(19) United States
(12) Patent Application Publication
(10) Pub. No.: US 2008/0179331 A1
(43) Pub. Date: Jul. 31, 2008

(54) Dispensing Closure Having Membrane Opening Device With Cutting Teeth

(75) Inventor: Jeffrey John Sharp, Hamilton (NZ)

Correspondence Address: KNOBBE MARTENS OLSON & BEAR LLP, 2040 MAIN STREET, FOURTEENTH FLOOR, IRVINE, CA, 92614, US

(73) Assignee: SJI LIMITED, Tauranga (NZ)

(21) Appl. No.: 11/914,631

(22) PCT Filed: May 15, 2006
(86) PCT No.: PCT/NZ2006/000113

§ 371 Date: Mar. 7, 2008

(30) Foreign Application Priority Data
May 16, 2005 (NZ) 540021

(51) Int. Cl. B65D 25/04; B67D 5/00

(52) U.S. Cl. 220/521; 222/83

(57) ABSTRACT

A dispenser closure (A) for a container including a storage chamber (2), a flexible diaphragm (3) and a membrane opening device (6) attached to the flexible diaphragm (3), whereby the membrane opening device (6) includes a support structure (7) in the form of an open structure with cutting teeth (11) in which a substance, additive, ingredient or powder to be dispensed may flow and out through the opened membrane. The open support structure results in mixing to occur immediately when the membrane is open, enables free movement of the substance, and facilitates complete mixing as there are fewer surfaces to trap the substance. Upon depression of the flexible diaphragm, the cutting teeth (11) of the opening device (6) moves to cut the membrane (5) thereby opening the storage chamber to allow the substance to mix with water, a solution or a sports drink contained in an attached container or bottle.

### TECHNICAL FIELD

This invention relates to a dispensing closure to be used in conjunction with a container.

In particular the present invention relates to a dispensing closure that keeps two or more substances separate until the dispensing closure is activated, thus enabling the substances to be mixed.

### BACKGROUND ART

Dispensers are used frequently to hold and, when activated, to add additives to water, other solutions or powders. These are often in the form of a dispensing closure which can be attached to a bottle or container in which the water, other solution or powder to which the additive is to be added, is contained. The dispensing closure holds the additive and once activated enables the substances to mix.

For example, dispensing closures are widely used in the pharmaceutical industry to keep one or more active ingredients separate from the solution in which they may be used, until the mixture is required. This is particularly useful in situations where the efficacy of the mixture may degrade with time. Use of a dispensing closure allows the active ingredient(s) to be added to the solution at the time of use, thus ensuring the mixture has the correct properties, concentration of ingredients and so on.

Another common use is for sports drinks where the active ingredient, for example an electrolyte, may be kept separate from the solution until immediately prior to use, thus maintaining the full efficacy of the mixture.

WO 2004/060766 provides a basis background to the present invention and early developments in the field. This document discloses a dispenser in the form of a blister pack which can be used to dispense a second substance into a container containing another substance. This dispenser also requires a second aperture, through which the mixed contents can be selectively removed from the container, and the container resealed.

This document also discloses a dispenser which incorporates a blister pack which ruptures on application of pressure.

Other documents, such as WO 2004/089777 and WO 03/043898 disclose dispensers incorporating a membrane opening device or cutter.

WO 2004/089777 discloses an arc shaped element which fits around the interior of the dispenser capsule/diaphragm to which pressure is applied to activate. The arc shaped element has at least one protruding or pointed element which acts to break the membrane seal separating the two substances.

JP 2004115075 discloses a dispensing closure, the body of which is formed in a single mould and includes a projection which is used to penetrate a membrane.

Typical dispensers include a space to hold the substance to be dispersed (the additive) which is bounded and sealed on one side by a membrane. A membrane opening device is used, typically activated by depression of a flexible diaphragm, which causes the membrane opening device to pierce the membrane, thus enabling mixing of the contents of the dispenser with those of the container to which it is attached in use.

There are however a number of disadvantages with current dispensing closures, such as those listed above. These relate primarily to difficulties encountered in ensuring that complete mixing of the substances occurs when the dispensing closure is activated.

One disadvantage is that there may be inefficient or only partial breaking of the seal/membrane. This can restrict the flow of substances between the dispensing closure and the container, leading to incomplete mixing of the substances in the dispensing closure and the container. Inefficient or incomplete mixing of the two substances is not desired as the concentration of the additive may be critical for some applications, such as in preparing pharmaceutical solutions.

For example, dispensing devices that rupture the membrane by pushing a spike through the membrane to form a hole, such as that disclosed in JP 2004115075, may be ineffective if the hole is not large enough to ensure free flow and mixing of the contents of the dispenser with those of the container to which it is attached in use. Shaking or other means of forcing the contents of the dispenser to mix with the contents of the container is time consuming and cannot guarantee complete mixing, as, for example, some additive may still remain trapped in the dispenser.

Increasing the size of the hole (for this type of dispenser) involves increasing the size of the spike used to form the hole. This solution however has the disadvantage of restricting the volume of the available space inside the dispensing closure used to store the additive compound.

This type of dispenser may not be appropriate for use with additives in the form of tablets. To dispense a tablet the hole in the membrane must be larger than the dimensions of the tablet so that the tablet may move freely and reliably from the dispenser into the container when the membrane is ruptured. This is a disadvantage of some current dispersers where the hole is small.

The mechanism used to break the membrane must also allow space for the tablet to access the resulting hole in the membrane. This is a disadvantage of dispensers that involve the use of a spike or other solid structure to pierce the membrane as typically the spike remains in close proximity to the hole formed in the pierced membrane after activation.

Some dispensing closures, such as that disclosed in WO 2004/089777, use a closed structure located inside the dispenser to make an arc shaped incision in the membrane. This type of piercing device typically limits the available space used to store the additive compound inside the dispensing closure. If the additive is in the form of the tablet it must be placed between the piercing structure and the membrane when the dispenser is constructed, in order to allow the tablet access the arc shaped hole in the membrane when formed. Again, the size of the opening in the membrane must be sufficiently large to ensure that the tablet will move through the opening without hindrance.

The use of a solid, closed structure has the added disadvantage of increasing the amount of material required to manufacture the dispenser. This increases the cost of production and hence the cost of the closure device when sold.

It is a considerable disadvantage if the mixing requires prolonged shaking in order for a solution from the container to enter the dispenser and dissolve the tablet. Incomplete mixing, and hence incorrect concentrations, may result if the tablet is not fully dissolved.

If the additive is in the form of a powder or liquid then there is the potential for some of the additive to be trapped behind the piercing structure which may lead to incomplete mixing.

The size of the hole is less important if the additive is in powder form. However it is important to ensure all of the powder can be combined and mixed with the solution in the container.

Again, a disadvantage with current dispensing disclosures may arise if the hole in the membrane limits the free flow of additive (powder or otherwise) or if the internal structure of the dispenser, and in particular the structure used to make the cut in the membrane, is such that access to the cut portion of the membrane is limited or if additive can be trapped inside the dispenser.

As in the case of additives in the form of tablets, shaking or other mixing activity required to ensure that all the additive has entered and been mixed with the contents of the container is time consuming and cannot be used to guarantee complete mixing. It is possible for the powder to get wet and stick to the inside of the dispensing closure instead of mixing with the substrate as desired.

A further significant disadvantage with most existing dispensers is that they comprise a number of distinct components. This is due in part to the different structural requirements of the components of the dispensing closure. For example, a dispensing closure normally requires a combination of a cap with rigid sides to screw onto a bottle, a flexible diaphragm section to activate a membrane opening device, and a membrane opening device strong and rigid enough to open a hole in a membrane.

Having the dispensing enclosure made up of a number of component parts increases the cost of manufacture and assembly, as a range of different products and moulds are required to manufacture the separate pieces, and slows the production rate due to the increased assembly required.

A further major disadvantage is that joins are often required between separate pieces. This introduces potential sealing problems between the separate components, and may lead to an increase in breakages or faulty operation.

It would be of advantage to people who manufacture or use dispensing closures if a dispensing closure were available which overcame the above disadvantages.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning i.e. that it will be taken to mean an inclusion of not only the listed components it directly references, but also other non specified components or elements. This rationale will also be used when the term ‘comprised’ or ‘comprising’ is used in relation to one or more steps in a method or process.

Further aspects and advantages of the present invention will become apparent from the ensuing description, which is given by way of example only.

### DISCLOSURE OF INVENTION

According to one aspect of the present invention there is provided a dispensing closure for use with a container

the dispensing closure including

a storage chamber configured to accommodate a substance to be dispensed,

a flexible diaphragm defining part of the storage chamber; and

a membrane opening device attached to the diaphragm and configured to open a

membrane when the diaphragm is activated

wherein the membrane opening device includes a support structure,

characterised in that

the support structure is in the form of an open structure through which the substance to be dispensed may flow and out through the opened membrane.

Throughout this specification the term container may be taken to refer to a bottle, onto which the dispensing closure can be attached. However this should not be seen as limiting as other forms of container may be used with the present invention.

In a preferred embodiment the dispensing closure is configured as a lid to the container.

As with a normal lid, the dispensing closure may be configured to be secured to the container. Preferably this securing means is that of a normal screw threaded closure commonly used on bottles for sealing by a lid or cap. However this should not be seen as limiting as other securing means may be utilised.

An advantage of using a dispensing closure with a common screw thread is that bottles do not have to be manufactured specifically for use with the dispensing closure of the present invention.

In one embodiment the dispensing closure may be releasably secured to the container. In operation this allows the dispensing closure to be activated to mix two substances together following which the container may be opened for use and then resealed for further use at a later time.

Having the container able to be opened and resealed multiple times after the dispensing closure has been activated may have significant advantages in some applications, such as for dispensing multiple doses of a medication over time. However this should not be seen as limiting as a single use dispensing closure may be made according to the present invention, and indeed is a preferred method of application.

In normal use the container contains a first substance to which a second substance, contained in the dispensing closure, may be mixed.

Throughout this specification the term storage chamber may be taken to refer to a space in the dispensing closure configured to accommodate the substance to be dispensed. Examples of such substances include, but are not limited to, active components or medication to be dispensed, chemicals for conducting testing of particular substances, or energy or health supplements.

The substance to be dispersed may be in the form of a tablet, a gas, a liquid, or a powder.

The dispensing closure allows the substance stored in the storage chamber to remain separate from the substance in the container until mixing is required. If the second substance contains an active component, this may prevent the active component from degrading or losing efficacy.

In a preferred embodiment the storage chamber contains a powder.

In a preferred embodiment the container contains a liquid.

Reference will be made throughout this specification to the storage chamber containing a second substance in the form of a powder and the container containing a first substance in the form of a liquid. However, those skilled in the art would appreciate that many other combinations of tablets, powders, gases and liquids are possible, and reference to a powder in the storage chamber and a liquid in the container should not be seen as limiting.

The dispensing closure incorporates a flexible diaphragm. The diaphragm may typically have a domed shape, i.e., convex away from the rest of the dispensing closure, and shall be referred to as having such herein. This configuration provides the amount of flexure and movement required to activate the dispensing closure. However this should not be seen as limiting as in some embodiments the diaphragm may be formed in other shapes or orientations, for example it may be substantially flat and horizontal.

In a preferred embodiment the design of the diaphragm and the side walls of the dispensing closure to which it is attached may also be configured to allow easy depression of the diaphragm.

For example, the design may include a depression around the periphery of the flexible diaphragm in the region between the diaphragm and the side wall of the dispensing disclosure. The depression allows the side of the dispensing closure to move inward as the diaphragm is depressed making downward movement of the diaphragm easier.

In a preferred embodiment the diaphragm may be protected by an overlying removable shroud (for example in the form of a bottle cap) to prevent accidental depression/activation of the diaphragm when the shroud is in place. The shroud may be removed when activation of the dispensing closure is required.

In a preferred embodiment the storage chamber includes a membrane.

In a preferred embodiment the membrane is positioned such that when the dispensing closure is attached to a container the membrane forms a barrier between the dispensing closure and an opening in the container. More specifically, the membrane is attached to the storage chamber and is positioned such that when the membrane is opened by the membrane opening device a hole is formed between the storage chamber and the interior of the container thus enabling mixing of the contents of the storage chamber with the contents of the container.

In a preferred embodiment the membrane may be an integral part of the dispensing closure.

In a preferred embodiment the membrane may be made of an inert material that does not react or interact with either the substance in the storage chamber or that in the container. This will prevent any adverse affects on either substance and maintain the purity and composition of the substances as intended.

In a preferred embodiment the membrane may be made of a material which may be readily ruptured and opened by the membrane opening device. Therefore the membrane burst strength should be limited to allow same, but not be so low that the membrane can rupture without activation of the dispensing closure.

Throughout this specification the term burst strength should be taken as meaning the minimum force required to be applied to the diaphragm in order to rupture and open the membrane with the membrane opening device.

In a preferred embodiment the membrane may be made from aluminium foil. However this should not be seen as limiting as membranes made from other materials that are suitable for contact with the substances in both the container and the storage chamber of the dispensing closure, may be utilised with the present invention.

Aluminium foil membranes are widely used in packaging where a secure seal is needed until the stored substance is required. A relatively small force is then used to rupture the membrane and release the substance.

An advantage in using an aluminium foil membrane is that it may be induction welded to the dispensing closure, thus forming a secure sealed closure. However this should not be seen as limiting as any other method suitable to securely attach the membrane to the dispensing closure may be utilised.

In a preferred embodiment the dispensing closure includes a membrane seat. The membrane seat may be in the form of a washer which supports the outer annular ring of the membrane against any pressure on it, thereby holding the membrane in position to allow the membrane opening device to efficiently rupture and open same when activated.

In a preferred embodiment the membrane and the membrane seat are located opposite the flexible diaphragm and in a plane substantially parallel to the plane through the base of the diaphragm.

In a preferred embodiment the membrane and the membrane seat are located so as to form a seal across the opening of the container when in use.

In an alternative embodiment the membrane and membrane seat may be located within the opening of the container when in use.

The dispensing closure device is activated to release the second substance by pressing the flexible diaphragm. This motion moves the membrane opening device such that it ruptures the membrane to form an opening through which the second substance can pass, thereby allowing the substances from the storage chamber and the container to mix.

In a preferred embodiment the membrane opening device is attached to the flexible diaphragm.

An advantage of attaching the membrane opening device to the diaphragm is that depression of the flexible diaphragm is immediately transferred into motion of the membrane opening device. In this manner the motion of the membrane opening device can be directly controlled through the application of appropriate force to the diaphragm. In particular, the full flex of the diaphragm is translated into movement of the membrane opening device, a situation that does not occur when the membrane opening device is not attached to the flexible diaphragm as in many of the prior art dispensers.

In a preferred embodiment the membrane opening device is attached to the diaphragm at intervals. This is an important feature that ensures full flexibility of the diaphragm is retained. Flexure of the diaphragm is translated into full movement of the membrane opening device when the diaphragm is activated by pressing it down. This complete flexure results in more efficient rupture of the membrane, for the least amount of force being exerted in order to flex the diaphragm.

In contrast, an extended attachment of the membrane opening device and the flexible diaphragm may severely restrict the motion of the flexible diaphragm. This arises because the flexible diaphragm and the connected section of the membrane opening device are constrained to move as one entity. General movement of the flexible diaphragm may therefore introduce significant forces between the membrane opening device and the flexible diaphragm which could lead to rupture of the connection and failure of the dispensing closure to operate properly.

In a preferred embodiment the membrane opening device is attached to the flexible membrane with a hinge.

Reference to a hinge throughout this specification should be understood to refer to a pliable part of a structure configured to bend when a force is applied to it. The use of suitable hinges to attach the membrane opening device to the flexible membrane allows the membrane opening device to move in a direction normal to the plane of the membrane when the diaphragm is pressed. This ensures that the membrane opening device is always in the optimum orientation relative to the membrane to rupture and open the membrane with the minimum applied force.

In a preferred embodiment the membrane opening device includes a hinge in the form of a thin section of material adjacent to where it is attached to the flexible diaphragm. This thin section of material acts as a form of hinge which flexes in response to the changing shape of the flexible diaphragm when the latter is depressed. With appropriate design this allows the remainder of the membrane opening device (ie other than the hinges) to be relatively rigid as required in order to rupture the membrane.

As the diaphragm is depressed it will typically move from a convex shape to a corrugated or more likely a concave shape. This changes the orientation of the flexible diaphragm relative to the membrane opening device at the attachment points. The force applied to the membrane opening device by the diaphragm is directed at right angles to the tangent plane of the surface of the diaphragm at the contact point. The direction of this force therefore changes continually as the diaphragm shape changes.

Use of a hinge in the membrane opening device where it is attached to the flexible diaphragm allows the hinge to bend such that membrane opening device moves in a direction substantially normal to the plane of the membrane at all times as the flexible diaphragm is pressed.

Without the use of a hinge the force on the membrane opening device at the attachment points would result in a tendency to splay the sides of the membrane opening device. If the membrane opening device is rigid the resultant force on the attachment point may be such as to break the attachment leading to failure of the membrane opening device.

In a preferred embodiment the membrane opening device includes a membrane opening surface.

In a preferred embodiment the membrane opening surface includes one or more teeth.

Reference will be made throughout this specification to the membrane opening surface including one or more teeth. However, those skilled in the art will know that membrane opening surfaces configured as other than teeth are possible and reference to the membrane opening surface as including teeth only should not be seen as limiting. For example, the membrane opening surface in some embodiments may include a blade.

In a preferred embodiment the teeth are arranged so as to open a substantially circular portion of the membrane.

Reference will be made throughout this specification to the teeth being arranged so as to open a substantially circular arc opening in the membrane. However, those skilled in the art will know that other configurations of the teeth are possible and reference to the teeth being arranged so as to open a substantially circular arc opening in the membrane only should not be seen as limiting. For example, the teeth may be arranged in some embodiments so as to form an opening consisting of two substantially straight cuts bisecting substantially at right angles. Essentially any shape of opening may be used provided it allows release of the substance to be dispensed without hindrance.

In a preferred embodiment the membrane opening device may extend from the diaphragm in a substantially semicircular shape, positioned substantially centrally on the diaphragm. However this should not be seen as limiting as other configurations may be utilised such as the membrane opening device extending around the exterior of the diaphragm or at angles across the middle of same.

In a preferred embodiment the membrane opening device is configured such that when the opening device is activated part of the membrane acts as an attachment point for the opened section of the membrane.

At least one portion of the membrane opening surface may be left without teeth (or other means to open the membrane) so that when the membrane is opened the opened portion of the membrane remains attached to the rest of the membrane. This provides the advantage that the opened portion of membrane remains attached and is unable to move around the container, thereby possibly interfering with future uses of the container.

The membrane opening device includes a support structure which links the membrane opening surface to the hinge attached to the diaphragm.

The support structure is in the form of an open structure configured such that the substance to be dispensed may flow through the support structure and out through the opened membrane.

Reference to an open structure throughout this specification should be understood to refer to a hollow structure including one or more gaps through which the substance to be dispensed may flow towards the opening in the membrane.

In a preferred embodiment the open support structure may consist of spaced apart legs. One end of each leg may be attached to a hinge attached to the diaphragm. The end of the leg distal to the diaphragm may be attached to the membrane opening surface. However, other forms of open structure are possible for the support structure and reference to the support structure including space apart legs only throughout this specification should not be seen as limiting.

The use of an open support structure means that immediately on opening of the membrane the substance to be dispersed may move readily from throughout the storage chamber, through the open support structure (if required) and into the container. Thus the membrane opening device does not need to return substantially to its original position before mixing can take place.

This is particularly the case when the substance to be dispensed is in the form of a powder or a liquid. The same result can be obtained when the substance to be dispensed is in tablet form by using an open structure having spaces through which the tablet or tablets can move.

The use of an open structure also means that there are fewer surfaces in the storage chamber which could trap the substance to be dispensed than in many existing dispensers. The open structure allows more space within the storage space for the material to be dispensed than is the case with many current dispensers having a solid membrane opening device. Also if the substance in the container is allowed to flow freely into the storage chamber it can more readily mix with the substance therein.

The open structure therefore overcomes some of the disadvantages of current dispensers by facilitating rapid and complete mixing of the contents of the storage chamber with the contents of the container following the opening of the membrane.

In a preferred embodiment the dispensing closure is made in one piece. In one piece construction the membrane (and possibly the membrane seat) is added to the dispensing closure following placement of the substance to be dispensed into the storage chamber.

One piece construction of the basic dispensing closure is made possible by the attachment of the membrane opening device to the diaphragm. With appropriate design a continuous single moulding is all that is required to produce a dispensing closure device as outlined herein.

Manufacture of the dispensing closure in one piece provides a significant number of advantages over previous dispensing closures which were manufactured in a number of separate pieces. One piece manufacture decreases the cost of manufacture significantly as no assembly required.

The one step process also allows a higher production rate. A single piece construction requires only one mould and production is not limited by further steps such as assembling a number of separate components.

A further advantage is that as the dispensing closure is made in one piece it is less likely to break or to have sealing problems at the attachment points, between for example the diaphragm and the storage chamber or the membrane.

In a preferred embodiment the dispensing closure is coated with material to enhance resistance to gas permeation.

In a preferred embodiment the dispensing closure is impregnated with at least one nano clay. Impregnation of nano clays into the plastic material of the dispensing closure may decrease permeability.

In a preferred embodiment the dispensing closure may be made of a material which allows the desired properties of the dispensing closure to be incorporated.

In a preferred embodiment the dispensing closure may be made of plastic. However, this should not be seen as limiting as other materials with the desired properties may also be utilised.

In a preferred embodiment the dispensing closure may be made of polyethylene or polypropylene.

In a preferred embodiment the storage chamber may have a substance inserted/placed into same, before the membrane is attached to the dispensing closure to form a closed unit. The membrane may then be welded (for example by use of ultrasonic heat or induction heat) or adhered (for example use of glue) to the membrane seat in order to create a fully enclosed storage chamber.

The design features discussed throughout this specification allow the disclosed dispensing closure to be moulded in one piece while still providing sufficient strength and rigidity of the closure to be able to be attached to the bottle while being flexible enough to easily depress the diaphragm and pierce the membrane.

In a preferred embodiment the dispensing closure leads to the formation of an effectively sealed package through a combination of the foil membrane with a coated impregnated cap which is possibly UV, oxygen, carbon dioxide and water vapour resistant. For example the internal or external surface of the storage chamber might also be coated with a material to enhance resistance to gas permeation through the closure.

In a preferred embodiment the dispensing closure of the present invention may be used in conjunction with a container having one opening, over which the dispensing closure is configured to fit.

In an alternative embodiment the dispensing closure of the present invention may be used with containers having two openings. The dispensing closure may be permanently attached to one opening perhaps by welding or gluing the membrane or membrane seat to both the dispensing closure and the container. The other opening in the container can be fitted with a screw cap, a sipper top or any other resealable opening.

According to another aspect of the present invention there is provided a method of using a dispensing closure as outlined above,

the method characterized by the step of:

applying a force to the flexible diaphragm sufficient to cause the membrane opening device to open a section of the membrane thus enabling the contents of the storage chamber to flow freely through the support structure and the open section of the membrane to mix with the contents of the container.

A dispensing closure according to the present invention provides a number of advantages over previous dispensing closures. In particular, the open structure used for the support structure of the membrane opening device enables free movement of the substance to be dispensed through the support structure and out into the container through the opened membrane when the closure device is activated.

In the present invention, as a result of the open support structure, mixing may occur immediately the membrane is opened. In contrast, in prior art dispensing closures there may be a delay prior to mixing of the contents while the membrane opening device is retracted into its original position, thus providing access to the opened membrane.

The open structure also facilitates complete mixing as there are fewer surfaces in the storage chamber able to trap the substance to be dispensed and prevent it from mixing with the contents of the container. The open structure allows more space to be used within the storage chamber for storing the substance to be dispensed. In the instance where the container holds a liquid, the use of an open support structure means that the liquid in the container can flow into the storage chamber through the opened membrane and freely move around inside the storage chamber. Each of these aspects provides an advantage over earlier dispensing closures in facilitating complete mixing of the components in the dispensing closure and the container when required.

The use of an open structure also reduces the amount of material required to construct the dispensing closure. This reduces production costs and therefore the cost of the dispensing closure to the consumer.

The design of the dispensing closure of the current invention allows it to be made in one piece rather than single pieces which are subsequently assembled into a finalised product. This has a number of advantages over earlier dispensing closures which contain a number of components that are made separately and assembled into the final product. These advantages over multi component disclosures include a decrease in manufacturing costs, as there is no assembly required, an increase in the production rate and a decrease in the number of breakages or problems with failed seals between components.

A feature of the dispensing closure as described herein is the attachment of the membrane opening device to the diaphragm only at certain intervals. This allows greater flexure of the diaphragm thus providing greater movement of the membrane opening device. This also overcomes problems with the prior art caused by the distortion forces between the extended contacts of the membrane opening device and the diaphragm. These forces in prior art dispensing closures reduce their efficiency or may lead to breakdown should the attachment rupture.

A further advantage of the current invention is the use of hinges to facilitate the attachment of the support structure of the membrane opening device to the diaphragm. The hinges are designed to flex when the diaphragm is depressed thus absorbing and accommodating the forces that would otherwise lead to potential rupture of the attachment.

These hinges may also be configured such that the membrane opening device is constrained to move directly towards the membrane, thus providing the most efficient transfer of force for opening the membrane. Current dispensing closures that do not have these features are less efficient and more likely to fail due to rupture of the attachment between the membrane opening device and the diaphragm.

The design of the dispensing closure according to the present invention is suitable for use with the substance to be dispensed in the form of powder, tablet, gas or liquid. In particular, the open support structure of the membrane opening device may be configured to allow free movement of the substance to be dispensed in any of these forms through the open support structure and out through the opened membrane into the attached container. In contrast, in many prior art dispensing closures the size and form of the membrane opening device is such that it may limit access of the dispensing material to the opening in the membrane, particularly when the substance is in the form of a tablet.

### BRIEF DESCRIPTION OF DRAWINGS

Further aspects of the present invention will become apparent from the ensuing description which is given by way of example only and with reference to the accompanying drawings in which:

FIG. 1 shows an external side view of a dispensing closure; and

FIG. 2 shows a vertical cross-section view of a dispensing closure; and

FIG. 3 shows a cross-section of a plan view of a dispensing closure; and

FIG. 4 shows a schematic of a diametrical cutaway perspective view of a dispensing closure; and

FIG. 5 shows a schematic of a dispensing closure attached to a container; and

FIG. 6 shows a cross-section of a side elevation of a dispensing closure including a shroud; and

FIG. 7 shows a schematic of a vertical cross-section cutaway perspective view of another embodiment of a dispensing closure.

### BEST MODES FOR CARRYING OUT THE INVENTION

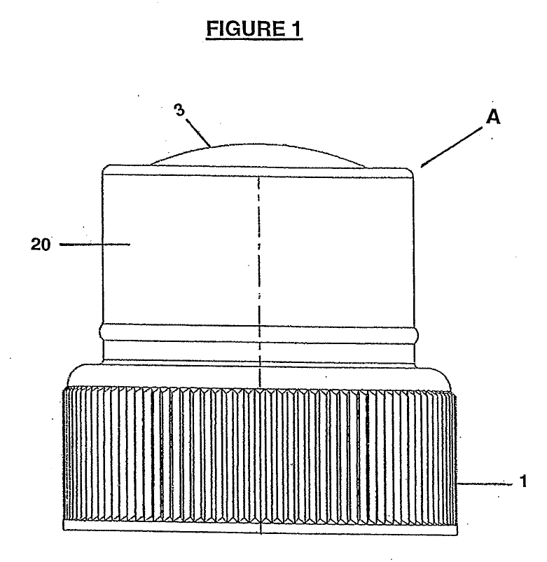

FIG. 1 shows a side elevation view of the exterior of a dispensing closure device according to the current invention, generally indicated as (A). The dispensing closure device is configured as a lid for a container (not shown in this Figure) where the dispensing closure device is attached to the container via a normal screw threaded closure (1). The dispensing closure device (A) includes a side wall (20) and a flexible diaphragm (3).

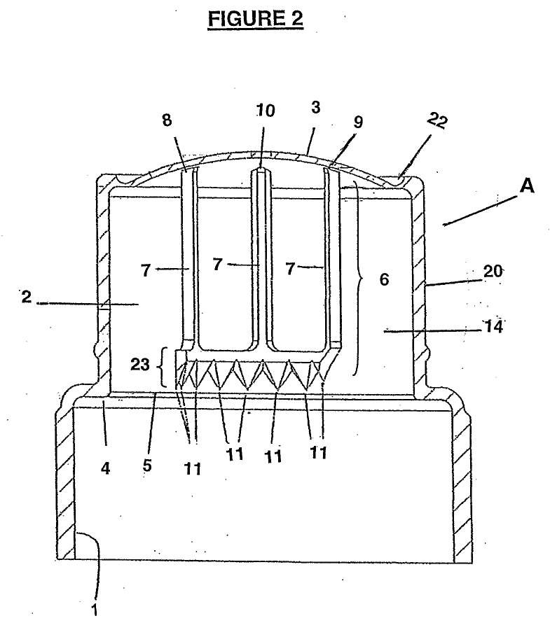

FIG. 2 shows a vertical cross-sectional view of a dispensing closure (A) including the normal screw threaded closure (1) for attachment to a container (interior screw thread not shown). A storage chamber (2) is formed by the space enclosed by the flexible diaphragm (3), the side wall (20) and the membrane (5) (when fitted).

A membrane seat (4) is positioned to hold the membrane (5) in position. The top of the container when sealingly attached to the dispensing closure device (A) sits against the side of the membrane seat (4) opposite from the membrane (5).

The membrane opening device, generally shown as (6), consists of a supporting structure (7) which is attached to the flexible diaphragm only at particular intervals (in this instance (8) and (9)), but not at others (in this instance (10)). The membrane opening device also includes a membrane opening surface, generally shown as (12). In this embodiment the membrane opening surface (12) includes teeth (11).

FIG. 2 shows a depression (22) around the periphery of the diaphragm between it and the side wall (20) of the dispensing closure, which allows the side wall (20) of the dispensing closure to move inwards as the diaphragm is depressed.

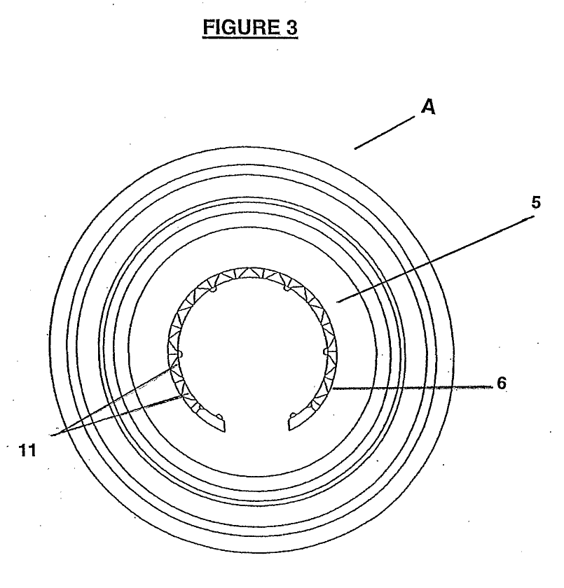

FIG. 3 shows a horizontal cross-sectional view through the membrane cutting surface of a dispensing closure (A). This Figure shows a typical substantially circular arc shaped membrane opening device (6) in a substantially central position above the plane of the membrane (5). The teeth (11) of the membrane opening device are shown in a substantially circular arc shape.

Activation of the membrane opening device (6) results in the membrane (5) being opened around the portion where teeth are present. The unopened section of the circle, corresponding to the section without teeth, ensures that the opened portion of the membrane remains attached to the remainder of the membrane after activation of the membrane opening device (6).

In a preferred embodiment the membrane opening device (6) has a number of pointed teeth (11) configured so that as well as having sharp points to pierce the membrane, the sides of the teeth are also sharp, allowing the membrane to be easily cut.

The diaphragm (3) may be designed to revert to its initial position, thus retracting the membrane opening device (6), or it may stay in the depressed position.

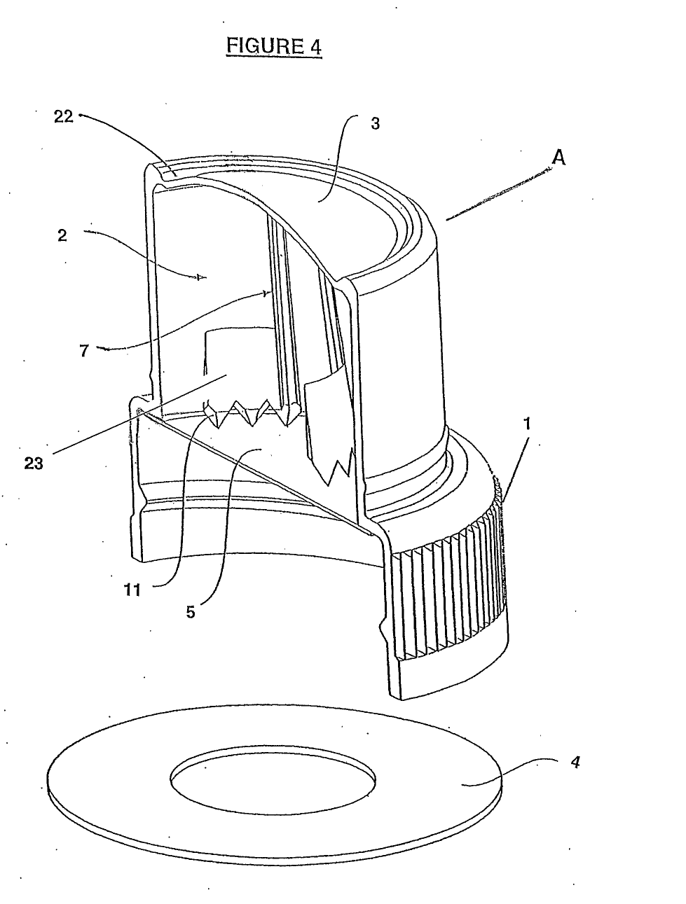

FIG. 4 shows a dispensing closure (A) including a portion (1) which functions as the screw threaded closure for a container such as a bottle (not shown), a storage chamber (2), a flexible diaphragm (3) and depression (22), a membrane seat (4), a membrane (5) and a membrane opening device showing the support structure (7), the membrane cutting surface (23) including cutting teeth (11).

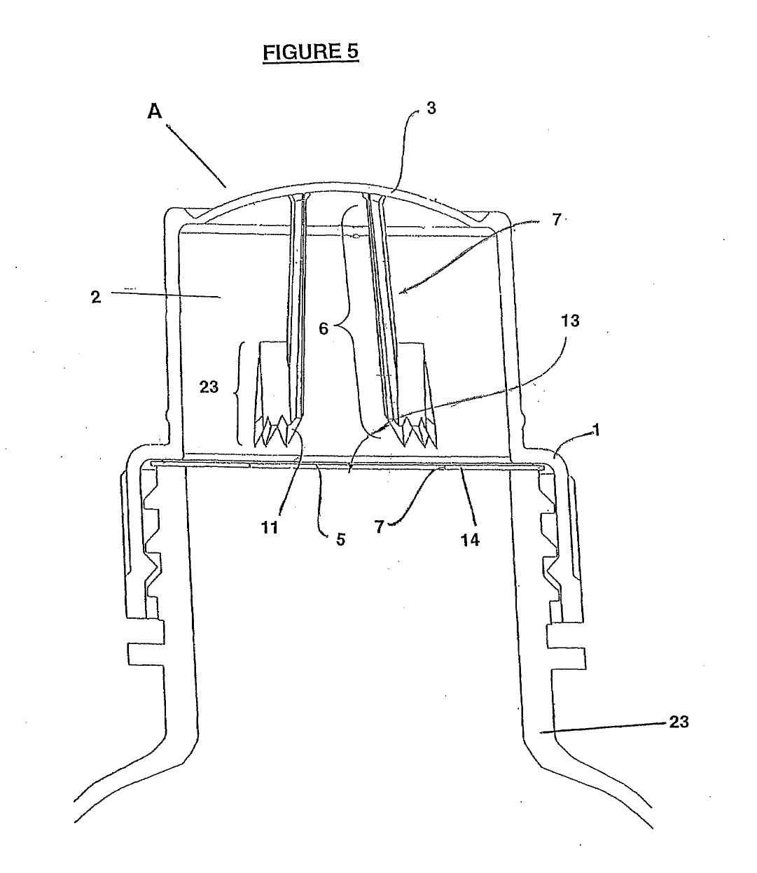

FIG. 5 shows a dispensing closure (A) attached to the top of a container (23). The opening (13) in the container (23) is sealed at the top by a membrane (5). The dispensing closure may also include an underlying membrane seat (14) in the form of a washer of compressible nature to ensure that any contents of the container do not leak past the closure threads (if any).

The membrane (5) when attached to the dispensing closure (A) is preferably in the form of a thin aluminium foil sheet, induction or ultrasonically welded or glued to the dispensing closure, which typically will be made of a plastics material.

The membrane opening device (6) extends from the diaphragm (3) towards the membrane (5) and is integrally moulded with the diaphragm as a single piece. The membrane opening device (6) preferably extends from substantially the centre of the diaphragm, which results in the greatest movement and efficiency when the diaphragm (3) is activated. Before the diaphragm (3) is activated the membrane opening device (6) does not touch the membrane (5).

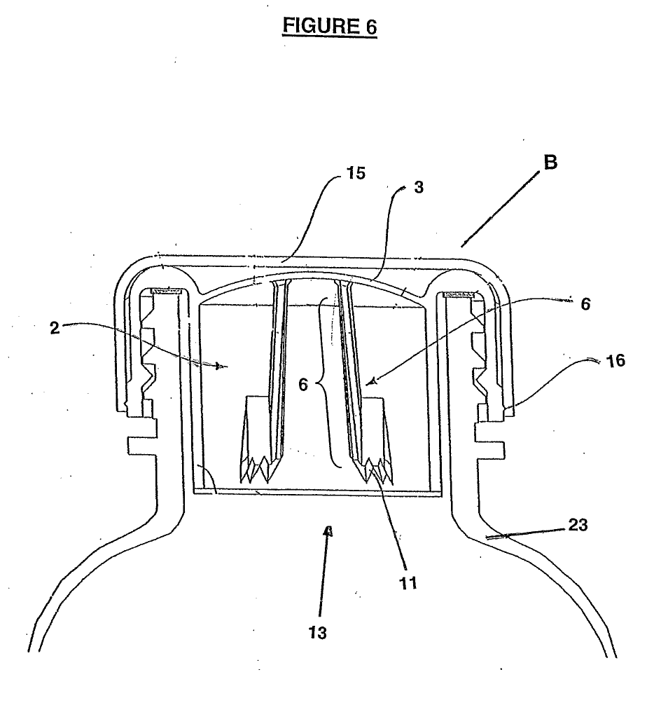

FIG. 6 shows another embodiment of a dispensing closure device, generally indicated by (B), in which the dispensing closure is recessed into the neck of the container (23).

FIG. 6 shows the positioning of a shroud (15) over the dispensing closure. It should be noted that the dispensing closure does not have to be recessed into the neck of the container for a shroud to be used, and indeed a shroud is preferred with all embodiments of the dispensing closure in order to prevent accidental activation of the diaphragm (3).

The shroud (15) is attached to the container (23) or the dispensing closure, by a retaining seat (16). The shroud (15) can be detached and re-attached to the retaining seat (16) as required, or alternatively discarded once the diaphragm (3) has been activated.

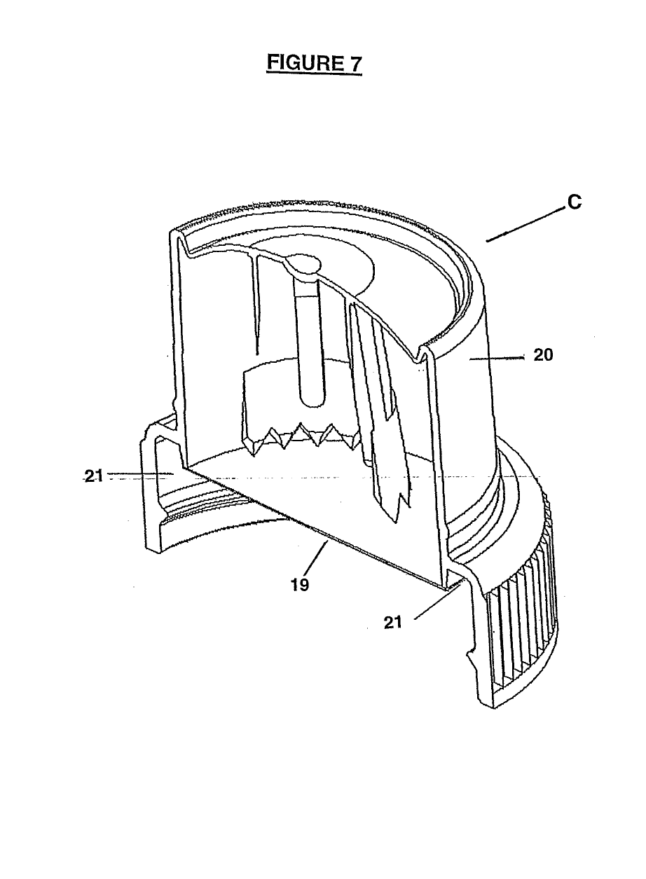

FIG. 7 shows a cross-section cutaway perspective view of another embodiment of a dispensing closure, generally indicated by (C), wherein a membrane (19) is attached, typically by welding or gluing, directly to the bottom of the sides (20) of the storage chamber. This embodiment has an indentation (21) in which the top edge of the container (not shown) sits when the dispensing closure is in position on the container.

Aspects of the present invention have been described by way of example only and it should be appreciated that modifications and additions may be made thereto without departing from the scope thereof as defined in the appended claims.

1. A dispensing closure for use with a container, the dispensing closure including
a storage chamber configured to accommodate a substance to be dispensed,
a flexible diaphragm defining part of the storage chamber;
a membrane opening device attached to the diaphragm and configured to open a membrane when the diaphragm is activated, and
a support structure joining the membrane opening device to the diaphragm, characterized in that the support structure is in the form of an open structure with at least one gap such that the substance to be dispensed may flow through the support structure and out through the opened membrane.

2. A dispensing closure as claimed in claim 1 wherein the dispensing closure is configured as a lid for the container.

3. A dispensing closure as claimed in claim 1 wherein the dispensing closure is made in one piece.

4. A dispensing closure as claimed in any claim 1 wherein the storage chamber can contain a powder.

5. A dispensing closure as claimed in any claim 1 wherein the storage chamber includes a membrane.

6. A dispensing closures claimed in claim 5 wherein the membrane is positioned such that when the dispensing closure is attached to a container the membrane forms a barrier between the dispensing closure and an opening in the container.

7. A dispensing closure as claimed in claim 5 wherein the membrane is made of aluminium foil.

8. A dispensing closure as claimed in claim 1, wherein the dispensing closure includes a membrane seat to support the periphery of a membrane.

9. A dispensing closure as claimed in claim 1 wherein the membrane opening device is attached to the diaphragm at intervals.

10. A dispensing closure as claimed in claim 1, wherein the membrane opening device is configured such that, when the opening device is activated, part of the membrane acts as an attachment point for the opened section of the membrane.

11. A dispensing closure as claimed in claim 1, wherein the membrane opening device includes one or more teeth.

12. A dispensing closure as claimed in claim 1, wherein the dispensing closure is coated with material to enhance resistance to gas permeation.

13. A dispensing closure as claimed claim 1, wherein the dispensing closure is impregnated with at least one nano clay.

14. A method of using a dispensing closure as claimed in claim 1, the method characterized by the step of:
applying a force to the flexible diaphragm sufficient to cause the membrane opening device attached to the diaphragm to open a section of the membrane such that the substance to be dispensed may flow through the support structure and out through the opened membrane.

15. A container including a dispensing closure as claimed in claim 1.

16-18. (canceled)
